(19) United States
(12) Patent Application Publication
(10) Pub. No.: US 2026/0196771 A1
(43) Pub. Date: Jul. 9, 2026

(54) CONDUCTOR TERMINAL AND ELECTRICAL PLUG CONNECTOR

(71) Applicant: WAGO Verwaltungsgesellschaft mbH, Minden (DE)

(72) Inventors: Finn Paul WELLING, Spenge (DE); Rudolf MASTEL, Minden (DE); Joel PALTEN, Bad Oeynhausen (DE); Henning MEIER, Bueckeburg (DE)

(73) Assignee: WAGO Verwaltungsgesellschaft mbH, Minden (DE)

(21) Appl. No.: 19/442,574

(22) Filed: Jan. 7, 2026

(30) Foreign Application Priority Data
Jan. 9, 2025 (DE) 20 2025 100 083.0

(51) Int. Cl. H01R 13/639; H01R 13/15

(52) U.S. Cl. CPC H01R 13/639; H01R 13/15

(57) ABSTRACT

A conductor terminal, having a housing and a plurality of spring-loaded terminal connections, each of which has at least one clamping spring for clamping an electrical conductor by spring-loaded force. The spring-loaded terminal connections are arranged along a ring-shaped path, in particular an a circular ring path, around a center in the housing of the conductor terminal. The conductor terminal has an individual actuating element for several or all of these spring-loaded terminal connections, which is assigned to the spring-loaded terminal connection, by the actuating of which the clamping spring of the assigned spring-loaded terminal connection can be individually actuated to an open position. An electrical plug connector, in particular a circular connector, comprising at least one such conductor terminal is also provided.

This nonprovisional application claims priority under 35 U.S.C. § 119(a) to German Patent Application No. 20 2025 100 083.0, which was filed in Germany on Jan. 9, 2025, and which is herein incorporated by reference.

### BACKGROUND OF THE INVENTION

### Field of the Invention

The invention relates to a conductor terminal having a housing and a plurality of spring-loaded terminal connections, each of which has at least one clamping spring for clamping an electrical conductor by spring-loaded force, wherein the spring-loaded terminal connection connections are arranged along a ring-shaped path, in particular an annular-shaped path, around a center in the housing of the conductor terminal, wherein the conductor terminal has an individual actuating element assigned to each of several or all of these spring-loaded terminal connections, which actuating element can be actuated to individually move the clamping spring of the assigned spring-loaded terminal connection to an open position. The invention also relates to an electrical plug connector, in particular a circular connector, having at least one such conductor terminal.

### Description of the Background Art

A generic conductor terminal is known from DE 10 2021 112 960 A1, which corresponds to US 2024/0088578, which is incorporated herein by reference.

### SUMMARY OF THE INVENTION

It is therefore an object of the present invention to provide an improved conductor terminal.

In an example of a conductor terminal, this object is achieved in that a respective individual actuating element has a first locking element with which the individual actuating element can be locked on a second locking element in the open position. Using the respective individual actuating elements, the user can transfer individual clamping springs to the open position depending on needs and circumstances, in each case independently of the other clamping springs. Advantageously, a clamping spring that is guided to the open position in this way is held in this open position by the assigned individual actuating element, because the individual actuating element is locked in the open position on the second locking element. As a result, the individual actuating element cannot simply move back to the original position, in particular not because of a restoring force of the clamping spring. In the open position, an electrical conductor can be guided to the clamping point without exerting force. The electrical conductor can then be clamped via the clamping spring, e.g., by the user manually releasing the locking mechanism of the individual actuating element on the second locking element. The individual actuating element thus also forms a retaining element for holding the clamping spring in the open position.

One, several or all of the individual actuating elements may be designed as sliding actuating push buttons or other sliding actuating element. In this way, the clamping springs can be moved to the open position by a sliding or pushing movement that is simple to execute.

The conductor terminal can have a release element assigned to an individual actuating element via which the locking mechanism of the individual actuating element in the open position can be released by manual actuation. By actuating a release element, the locking mechanism of a single individual actuating element can be released. It is also possible that a release element is assigned to several individual actuating elements, so that by actuating such a release element, the locking mechanism of several individual actuating elements can be released.

The first locking element can be designed either as a protruding locking projection or as a locking recess. The second locking element is then correspondingly designed as the counterpart, i.e., as a locking recess if the first locking element is designed as a locking projection, and in the reverse case, as a locking projection. If the first locking element is designed as a locking projection, it may protrude slightly from the housing or at least be accessible for manual actuation on the outside of the housing. In this way, the first locking element or at least a section of the first locking element accessible on the outside of the housing can also form the release element for releasing the locking mechanism.

A guide groove or a guide slot can be formed on the housing, in which the first locking element of a given individual actuating element is guided when moving from the unactuated state to the open position. This allows for a defined guidance of the individual actuating element and, in particular, its first locking element, so that a specified sequence of movements is ensured during actuation and there is no undesirable jamming or snagging.

In the area of the open position, the respective guide groove or the guide slot may transition to the second locking element. This has the advantage that the first locking element is guided specifically to the second locking element via the guide groove, so that a secure locking position in the open position is guaranteed. The guide groove can be molded on the inside of the housing, for example. The guide slot can be shaped as an elongated slot penetrating the outer wall of the housing. The second locking element can be designed as a return or an abrupt change in the course of the guide groove or guide slot.

One, several or all of the individual actuating elements can each have an elastically deformable locking arm on which the first locking element is arranged, wherein the locking arm springs back elastically when the first locking element engages in the locking mechanism on the second locking element. In this way, a simple and cost-effective locking mechanism can be created, in which, for example, the elastic properties of plastic can be used to achieve secure locking. For example, the entire individual actuating element or at least its locking arm can be made of plastic.

The locking arm can project radially outwards relative to the center of the housing. It is also possible that the locking arm extends within the housing in an axial direction.

In one, several or all individual actuating elements, the respective first locking element can be locked on the second locking element via a radially outward movement and/or a tangential movement along the circumference of the housing. In this way, a secure locking mechanism can be realized that is simple and cost-effective.

One, several or all of the individual actuating elements can have a respective manual actuating section protruding from the housing in the axial direction, e.g., at an end face of a round housing. The manual actuating section is used for simple and ergonomic manual actuation of the respective individual actuating element, e.g., by applying pressure in the axial direction.

In one, several or all individual actuating elements, the respective first locking element can project radially from the housing, at least when it is engaged with the second locking element. This also makes it easy for the user to see that the respective clamping spring is in the open position and that the individual actuating element is locked in this open position. Furthermore, the first locking element can then also be used as a release element, which is particularly advantageous.

The housing for one, several or all spring-loaded terminal connections can have a conductor entry channel assigned to the spring-loaded terminal connection, through which an electrical conductor can be inserted into the housing and clamped to the spring-loaded terminal connection. This has the advantage that an electrical conductor can be guided precisely to a clamping point in the housing, where the electrical conductor can then be clamped via the clamping spring, e.g., to a busbar.

The housing can be designed as an insulating material housing, for example. The housing can be an essentially cylindrical round housing.

One, several or all of the individual actuating elements may each have a longitudinal guide section, which is guided within a conductor entry channel in a longitudinal displacement direction. This has the advantage that the conductor entry channel can simultaneously be used as a bearing and guide for a respective individual actuating element. This allows for the conductor terminal to be designed in a particularly compact manner.

A respective longitudinal guide section guided in a conductor entry channel can extend circumferentially over at least half of the circumference of the conductor entry channel. For example, the longitudinal section can have a U-shaped cross-sectional shape. In this way, the longitudinal guide section is guided with little play in the conductor entry channel and can be easily displaced. The longitudinal guide section thus at least partially assumes the conductor guide function of the conductor entry channel. Accordingly, such a longitudinal guide section surrounds an electrical conductor inserted into the conductor entry channel over at least half its circumference.

The individual actuating elements can be arranged immediately adjacent to each other in the center of the housing and/or mutually support each other. The individual actuating elements, like the spring-loaded terminal connections, can also be arranged in a ring shape, in particular in a circular ring shape, within the housing. This simplifies the mounting of the individual actuating elements and minimizes the space required. Furthermore, it simplifies the assembly of the individual components of the conductor terminal. The individual actuating elements can, for example, be shaped like circular sectors or pie slices towards the center of the housing.

The conductor terminal can have at least one general actuating element, via which the clamping springs of several or all of the spring-loaded terminal connections, that can be actuated via an individual actuating element, can be jointly actuated together to the open position when a manual actuating section of the general actuating element is actuated. This allows for the user of such a conductor terminal, depending on need and situation, to actuate individual clamping springs or only one clamping spring to the open position, either by actuating the respective individual actuating element, or alternatively, by actuating the general actuating element, to actuate the clamping springs of all spring-loaded terminal connections that can be actuated via the general actuating element to the open position simultaneously. Actuating several or all spring-loaded terminal connections via the general actuating element is helpful, for example, when wiring the conductor terminal for the first time. However, if partial rewiring is required on an already wired conductor terminal, it is often not desirable to actuate all clamping springs to the open position, but only those clamping springs that are to be rewired. For this purpose, individual actuating elements can then be actuated by the user in a targeted manner. Due to the general actuating element, the clamping springs, for example, can be actuated directly to the open position. The general actuating element can be designed, for example, as a linearly movable actuating push button.

The general actuating element can be configured to indirectly actuate the respective clamping spring to the open position by actuating the individual actuating element assigned to this clamping spring. In this case, the individual actuating element can be subjected to an actuating force via an actuating contour of the general actuating element.

The manual actuating section of the general actuating element can protrude from the housing in the axial direction. This allows for simple manual actuating of the general actuating element by applying a compressive force in the axial direction. Advantageously, the general actuating element can be moved in the same direction as the individual actuating elements. The general actuating element can be actuated on the same side of the housing as the individual actuating elements.

The manual actuating section of the general actuating element can be divided into several separate sectors which can be actuated independently. This allows for an advantageous simplification in the manufacture of the entire actuating arrangement of the conductor terminal, as the individual actuating elements can be shaped like circular sectors, as mentioned above, and can transition directly to a sector of the general actuating element in the center of the housing. The sectors of the general actuating element can, for example, be circular sectors.

A respective sector of the manual actuating section of the general actuating element can be coupled to a respective individual actuating element or is integrally formed with it. This allows for the simple manufacture of the individual actuating element and the general actuating element. For example, a unit consisting of an individual actuating element and a general actuating element can be manufactured as a plastic injection-molded component.

The general actuating element, or at least its manual actuating section, can be arranged in a central area of the conductor terminal, which is located within the area bounded by the annular path of the spring-loaded terminal connections. This allows for simple manual actuating of the general actuating element.

The object mentioned above is also achieved by an electrical connector, in particular by a round plug connector, which has at least one conductor terminal of the type explained above. This also allows for the advantages explained above to be realized.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a conductor terminal with a partially open housing in a perspective view,

FIG. 2 is an individual actuating element of the conductor terminal according to FIG. 1,

FIG. 3 shows the conductor terminal according to FIG. 1 in an axial plan view,

FIG. 4 shows the conductor terminal according to FIG. 1 in a side view in the unactuated state,

FIG. 5 shows the conductor terminal according to FIG. 4 in the actuated state,

FIG. 6 is a spring-loaded terminal connection and an individual actuating element of the conductor terminal according to FIG. 1 in the unactuated state,

FIG. 7 shows the arrangement according to FIG. 6 in the actuated state,

FIG. 8 is an example of a conductor terminal in a perspective view in the unactuated state,

FIG. 9 shows the conductor terminal according to FIG. 8 in the actuated state, and

FIG. 10 is an individual actuating element of the conductor terminal according to FIG. 8.

### DETAILED DESCRIPTION

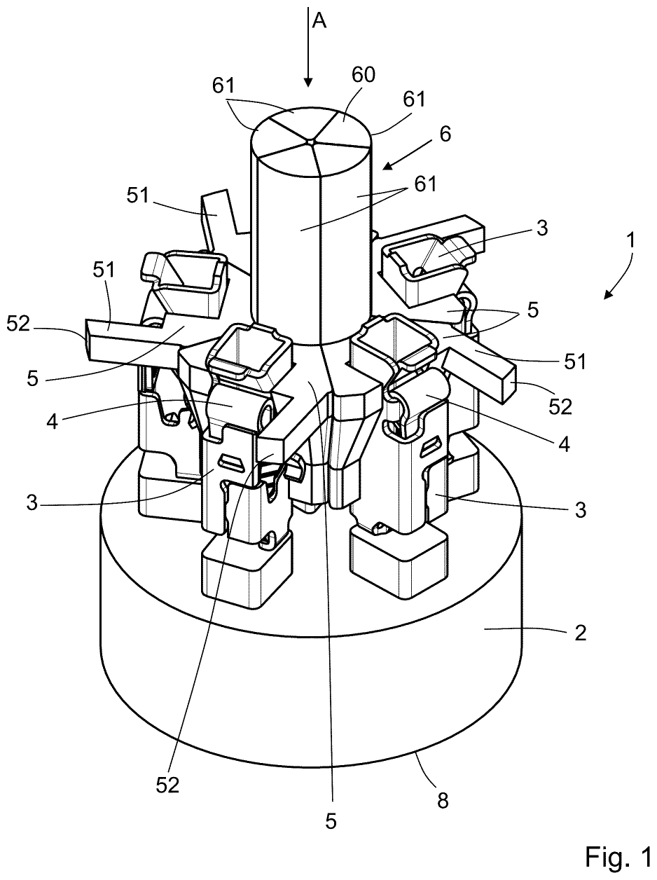

The conductor terminal 1 shown in FIG. 1 has a housing 2, which can be designed as a round housing, for example. The conductor terminal 1 may have electrical plug contacts on one plug-in side 8, with which the conductor terminal 1 can be plugged together with a mating connector in the manner of a round connector to form an electrical plug connector. The conductor terminal 1 has several spring-loaded terminal connections in the housing 2. The spring-loaded terminal connections each have a busbar component 3 and a clamping spring 4. The busbar component 3 may be designed as a frame-like busbar component 3 in the manner of a contact frame, in which the clamping spring 4 is at least predominantly arranged.

As can be seen, the spring-loaded terminal connections are arranged in a circular path around a center in the housing 2. The spring-loaded terminal connections are arranged within the housing 2, at least if the housing 2 is closed via another housing component. The spring-loaded terminal connections or their clamping springs 4 can be deflected to an open position, e.g., by deflecting a clamping leg of the clamping spring from a clamping position to an open position in which an electrical conductor can be placed at a clamping point without effort.

To transfer the respective clamping spring to the open position, the conductor terminal has several individual actuating elements 5. An individual actuating element 5 is assigned to each spring-loaded terminal connection. As you can see, the individual actuating elements 5 are also arranged in the annular shape and meet in the center of the housing, wherein the individual actuating elements 5 can support each other in the center or at least touch each other. A first locking element 52 is arranged on each individual actuating element 52, wherein in the example shown, each individual actuating element 5 has a locking arm 51 that protrudes radially outwards, at the free end of which the respective first locking element 52 is formed.

In the center of the housing, the conductor terminal 1 has a general actuating element 6, via which the clamping springs 4 of all spring-loaded terminal connections can be actuated together to the open position. The general actuating element 6 has a manual actuating section 60 to which a compressive force in the axial direction A can be applied to actuate the general actuating element 6. As can be seen, the general actuating element 6, like the individual actuating element 5, is also divided into individual circular sectors, with a circular sector 61 of the general actuating element 6 being assigned to or connected to an individual actuating element 5.

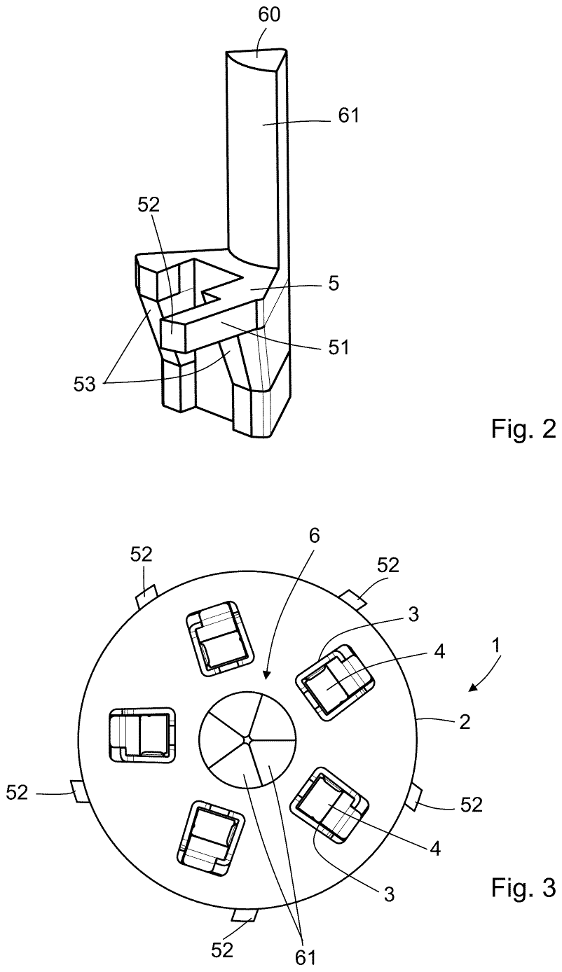

FIG. 2 shows an individual actuating element 5, to which a circular sector-shaped section 61 of the general confirmation element 6 is molded in a single piece. The locking arm 51 with the first locking element 52 can also be seen. The individual actuating element 5 also has actuating angles 53, via which the clamping leg of a respective clamping spring can be deflected to the open position in a displacement direction when the individual actuating element 5 is actuated.

FIG. 3 shows the conductor terminal 1 with a closed housing 2 in an axial plan view of the side where the general actuating element 6 is located. It can be seen that the first locking elements 52, or possibly also a part of the respective locking arm 51, radially protrude slightly from the housing 2. The spring-loaded terminal connections with the respective busbar component 3 and the clamping spring 4 inserted in it can also be seen.

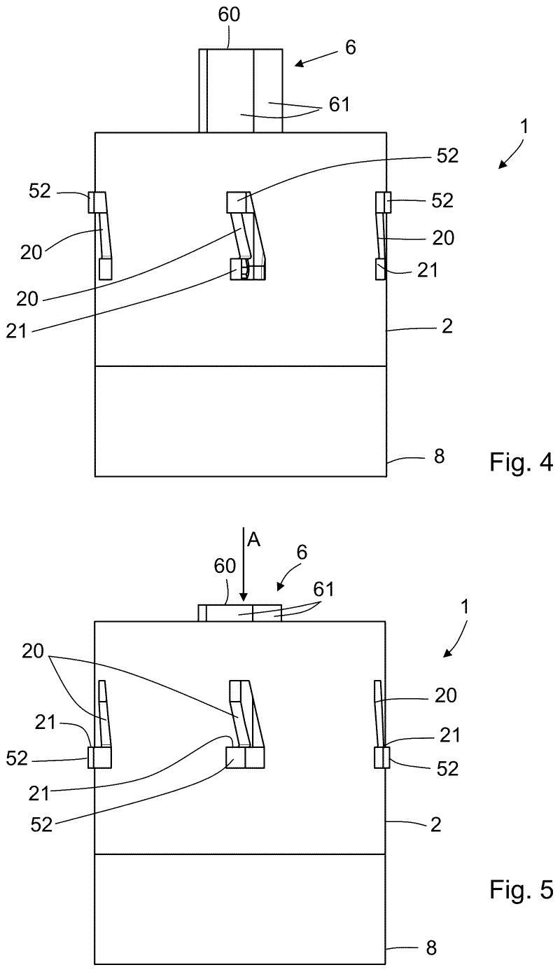

FIG. 4 shows the conductor terminal 1 in a side view with the housing closed, wherein, as in FIG. 1, the individual actuating elements 5 and the general actuating element 6 are not actuated, i.e., the clamping springs are not yet in the open position. It can be seen that the outer wall of the enclosure 2 on the circumferential side has a guide slot 20 assigned to an individual actuating element 5, in which a respective locking element 52 and/or a respective locking arm 51 is guided during axial displacement as a result of manually actuating the individual actuating element 5 or the general actuating element 6. As you can see, the guide slots 20 do not run exactly in the axial direction or parallel to the axial direction but are aligned at a slight angle. At the lower end, the respective guide slot 20 transitions to a second locking element 21, with which the first locking element 52 can be engaged. The second locking element 21 can be designed as a recess in a guide slot 20.

When an individual actuating element 5 is axially displaced as a result of a manual actuation of the individual actuating element 5 or the general actuating element 6, the locking arm 51 is deformed somewhat elastically due to the oblique course of the guide slot 20, which results in a certain tension of the individual actuating element 5. When the first locking element 52 is engaged with the second locking element 21, the locking arm 51 springs back at least partially, so that a secure locking mechanism is guaranteed.

FIG. 5 shows the conductor terminal according to FIG. 4 in the actuated state. For example, by actuating the general actuating element 6 in the axial direction A, all clamping springs 4 are transferred to the open position. Due to the single-piece design of the general actuating element 6 or its sectors 61 with a respective individual actuating element 5, the individual actuating elements 5 have accordingly also been displaced in the axial direction. In this open position, a first locking element 52 is now engaged with a second locking element 21.

To release this lock, the lock on the second locking element 21 can be removed by manually actuating the first locking element 52. To do this, the first locking element 52 must first be moved somewhat tangentially in the circumferential direction, wherein the locking arm 51 connected to the first locking element 52 is deflected somewhat spring-elastically. The return movement to the unactuated position, as shown in FIG. 4, can then be carried out automatically due to the return spring force of the clamping spring 4 acting on the individual actuating element 5 and, if necessary, can also be supported manually.

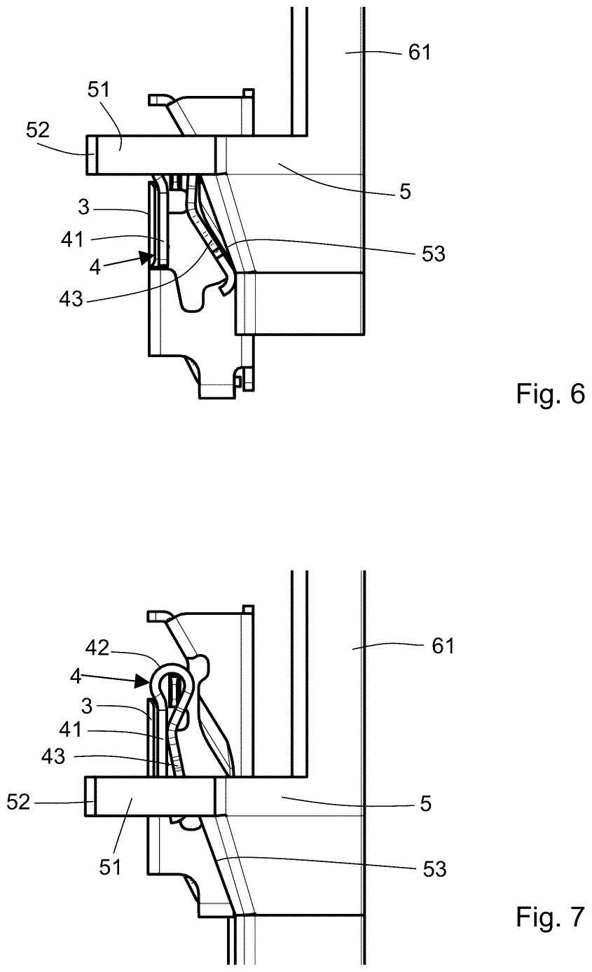

FIG. 6 shows a single individual actuating element 5 with the assigned spring-loaded terminal connection in the unactuated state; FIG. 7 shows the same arrangement in the actuated state, in which the clamping spring 4 is transferred to the open position. It can be seen that the clamping spring 4 has a contact leg 41, which is connected to a clamping leg 43 via a spring bow 42. The clamping leg 43 is used to clamp an electrical conductor to a wall section of the frame-shaped busbar element 3. The clamping spring 4 is supported by its contact leg 41 on an opposite wall section of the frame-shaped busbar element 3. If the individual actuating element 5 or the general actuating element 6 is transferred from the unactuated state to the actuated state, the clamping leg 43 is deflected in the direction of the contact leg 41 by the actuating angle 53.

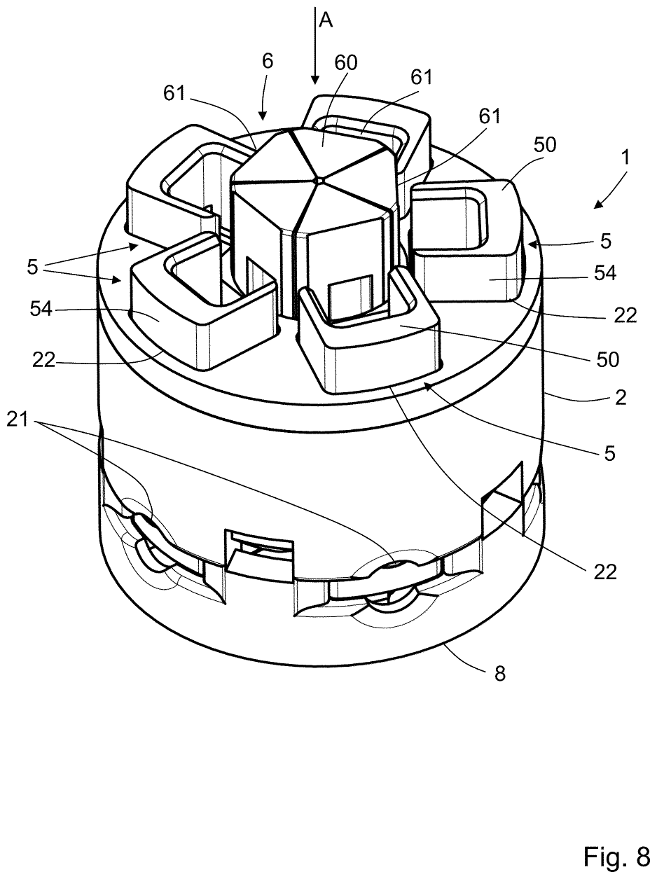

FIG. 8 shows an example of a conductor terminal 1 with a housing 2, which can be designed as a round housing, for example. The conductor terminal 1 may have 8 electrical plug contacts on one plug-in side, with which the conductor terminal 1 can be plugged together with a mating plug connector in the manner of a circular connector to form an electrical plug connection. The conductor terminal 1 in turn has the spring-loaded terminal connections arranged in an annular shape around a center of the housing 2, as explained above, which are arranged in the housing 2. Each spring-loaded terminal connection is in turn assigned an individual actuating element 5 for individual actuation of the clamping spring 4.

In this case, the individual actuating elements 5 are arranged in a respective conductor entry channel 22 of the housing 2 and are guided therein in the axial direction of actuation. It can be seen that the individual actuating elements 5 each have a longitudinal guide section 54, which is located within the conductor entry channel 22. The longitudinal guide section 54 extends in the circumferential direction over at least half of the circumference of the conductor entry channel 22. In the example shown, the longitudinal guide section 54 extends in the circumferential direction over about 75% of the circumference of the conductor entry channel 22. As can be seen, the respective individual actuating element 5, with a manual actuating section 50, protrudes from the housing 2 in the axial direction. At the manual actuating section 50, each individual actuating element 5 can be actuated manually by the user.

In the center of the housing, the conductor terminal 1 has a general actuating element 6, through which the clamping springs 4 of all spring-loaded terminal connections can be actuated together to the open position. The general actuating element 60 has a manual actuating section 60 in the center of the housing 2, to which a compressive force can be applied to actuate the general actuating element 6. As can be seen, the general actuating element 6 is divided into individual sectors 61, wherein in each case a sector 61 of the general actuating element 6 is assigned to or connected to an individual actuating element 5.

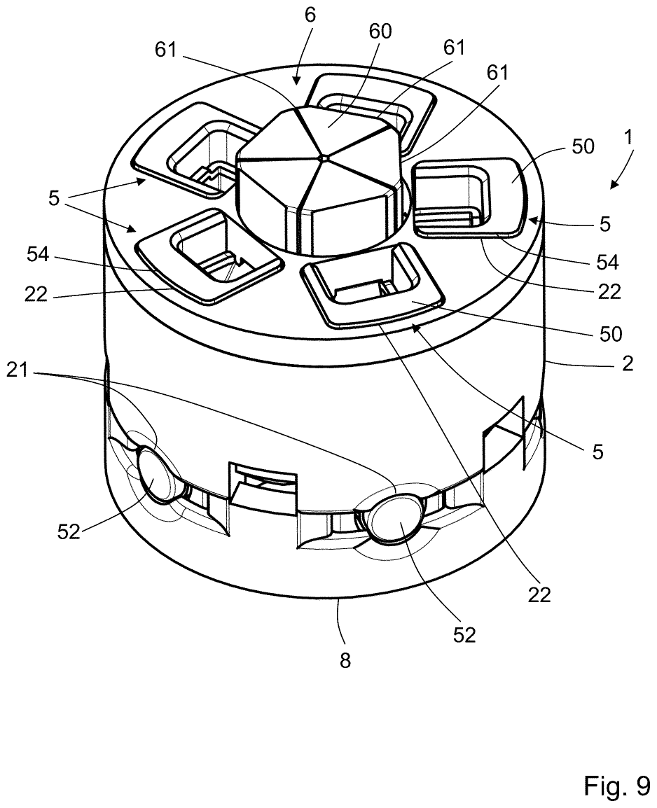

FIG. 8 shows the conductor terminal 1 in the unactuated state; FIG. 9 shows the conductor terminal 1 in the actuated state of all individual actuating elements 5 or the general actuating element 6. As can be seen, in the actuated state, in which the clamping springs 4 are transferred to the open position, a respective first locking element 52 of an individual actuating element 5 is engaged with a second locking element 21 arranged on the housing 2. The locking can be individually released for each spring-loaded terminal connection by the user exerting a compressive force on the respective first locking element 52 in a radial inward direction. Then the restoring force of the clamping spring moves the respective individual actuating element 5 back to the unactuated position.

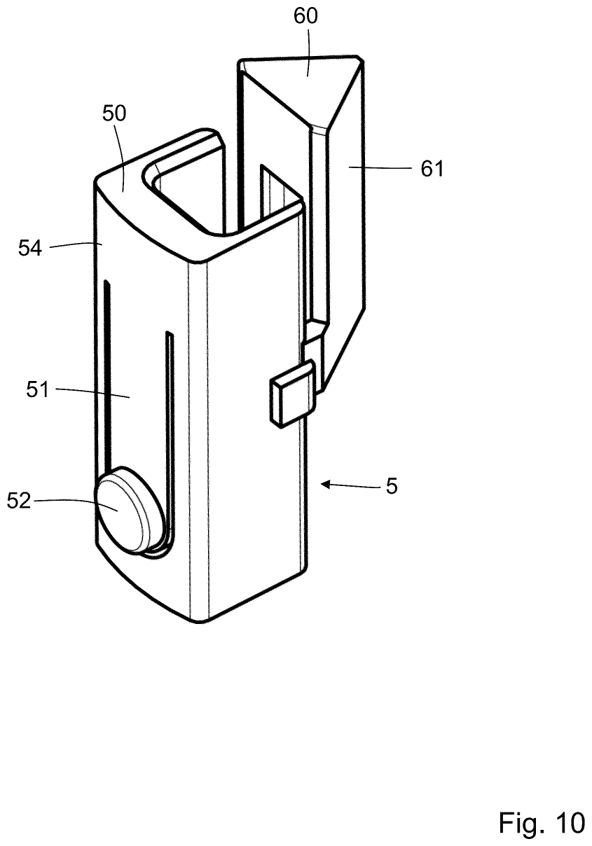

FIG. 10 shows an individual actuating element 5, together with a sector 61 of the general actuating element 6 of the conductor terminal according to FIGS. 8 and 9. In this case, sector 61 can in turn be molded into a single piece with the individual actuating element 5, e.g., as a plastic injection molded component. It can be seen that the individual actuating element 5 has a locking arm 51 extending in the axial direction on the radially outward-facing side of the longitudinal guide section 54, which locking arm has a first locking element 52 at its free end. The locking arm 51 can be deflected with spring elasticity. In an example, the first locking element 52 can be guided in an internal guide groove of the housing 2 during the displacement process of the individual actuating element 5.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal comprising:
a housing; and
at least two spring-loaded terminal connections, each of which has at least one clamping spring for a spring-loaded connection of an electrical conductor, the spring-loaded terminal connections being arranged along a ring-shaped track around a center in the housing of the conductor terminal,
wherein the conductor terminal for several or all of the spring-loaded terminal connections each has an individual actuating element assigned to the spring-loaded terminal connection, by the actuating of which the clamping spring of the assigned spring-loaded terminal connection is adapted to be individually actuated to an open position, and
wherein a respective individual actuating element has a first locking element with which the individual actuating element is adapted to be locked in the open position on a second locking element.

2. The conductor terminal according to claim 1, wherein the conductor terminal has a release element assigned to each individual actuating element, via which the locking of the individual actuating element in the open position is adapted to be released via manual actuation.

3. The conductor terminal according to claim 1, wherein a guide groove or a guide slot is formed on the housing, in which the first locking element of a respective individual actuating element is guided from the unactuated state to the open position the movement.

4. The conductor terminal according to claim 3, wherein, in the area of the open position, the respective guide groove or the guide slot transitions to the second locking element.

5. The conductor terminal according to claim 1, wherein one, several or all of the individual actuating elements each have an elastically deformable locking arm on which the first locking element is arranged, and wherein the locking arm springs back elastically when the first locking element transitions to the locking position on the second locking element.

6. The conductor terminal according to claim 5, wherein the locking arm protrudes radially outwards, relative to the center of the housing.

7. The conductor terminal according to claim 1, wherein, in a case of one, several or all individual actuating elements, the respective first locking element is adapted to be latched to the second locking element via a radial outward movement and/or a tangentially directed movement along the circumference of the housing.

8. The conductor terminal according to claim 1, wherein one, several or all of the individual actuating elements have a respective manual actuating section protruding in an axial direction from the housing.

9. The conductor terminal according to claim 1, wherein, in the case of one, several or all individual actuating elements, the respective first locking element protrudes from the housing in a radial direction, at least when it is engaged with the second locking element.

10. The conductor terminal according to claim 1, wherein the housing for one, several or all spring-loaded terminal connections has a respective conductor entry channel, each assigned to the spring-loaded terminal connection, through which an electrical conductor is adapted to be inserted into the housing and clamped to the spring-loaded terminal connection.

11. The conductor terminal according to claim 10, wherein one, several or all of the individual actuating elements each have a longitudinal guide section, which is guided within a conductor entry channel in a longitudinal displacement direction.

12. The conductor terminal according to claim 11, wherein a respective longitudinal guide section guided in a conductor entry channel extends in the circumferential direction over at least half of the circumference of the conductor entry channel.

13. The conductor terminal according to claim 1, wherein the individual actuating elements in the center of the housing are immediately adjacent and/or support each other.

14. The conductor terminal according to claim 1, wherein the conductor terminal has at least one general actuating element, via which the clamping springs of several or all of the spring-loaded terminal connections, which are adapted to be actuated via an individual actuating element, are adapted to be actuated together to the open position when a manual actuating section of the general actuating element is actuated.

15. The conductor terminal according to claim 14, wherein the manual actuating section of the general actuating element protrudes from the housing in the axial direction.

16. The conductor terminal according to claim 14, wherein the manual actuating section of the general actuating element is divided into several separate sectors, which are adapted to be actuated separately from each other.

17. The conductor terminal according to claim 16, wherein a respective sector of the manual actuating section of the general actuating element is coupled with a respective individual actuating element or is shaped into a single piece therewith.

18. The conductor terminal according to claim 14, wherein the general actuating element is configured to indirectly actuate the respective clamping spring to the open position by actuating the individual actuating element assigned to this clamping spring.

19. The conductor terminal according to claim 14, wherein the general actuating element, or at least its manual actuating section, is arranged in a central region of the conductor terminal, which is within the area bounded by the annular path of the spring-loaded terminal connections.

20. An electrical plug connector, in particular circular connector, comprising at least one conductor terminal according to claim 1.
